(19) United States
(12) Patent Application Publication
(10) Pub. No.: US 2008/0285461 A1
(43) Pub. Date: Nov. 20, 2008

(54) METHOD FOR REMOTELY MONITORING SYSTEM

(75) Inventor: Ming-Chen Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INVENTEC CORPORATION, Taipei City (TW)

(21) Appl. No.: 11/748,499

(22) Filed: May 15, 2007

(51) Int. Cl. G06F 11/00

(52) U.S. Cl. 370/241

(57) ABSTRACT

A method for remotely monitoring a system is provided. In the present invention, when a computer system receives a network packet sent by a remote device, it determines whether the network packet is a remote management control protocol (RMCP) packet. If the network packet is a RMCP packet, the data content of the RMCP packet is parsed and a corresponding monitoring operation is executed to obtain a monitoring result. Finally, the monitoring result is transmitted back to the remote device. Accordingly, the computer system can be remotely monitored through the network without using a Baseboard Management Controller (BMC), so that the hardware cost can be saved.

### BACKGROUND OF THE INVENTION

1. Field of the Invention

The present invention generally relates to a method for monitoring a system, in particular, to a method for remotely monitoring a computer system through a network.

2. Description of Related Art

Along with the rapid advancement of computer and network technologies, a system administrator can obtain the hardware status of a computer system not only by monitoring the computer system or from the system event log, but also by executing monitoring operations through remote connection via a local area network (LAN). Accordingly, the status of the computer system can be monitored from anywhere at anytime.

Besides, a common standard is established for monitoring different computer systems at the same time, wherein the standard includes an intelligent platform management interface (IPMI) which is established regarding trans-platform system management. Monitoring systems adopting this IPMI include internal monitoring system circuit, external overall management hardware, and various management software. A chip with such a structure for carrying out various monitoring operations in a computer system is called baseboard management controller (BMC). Generally speaking, monitoring internal operations of a computer system with a BMC has become a mainstream in computer monitoring systems.

Some computer system manufacturers provide external BMC designs to reduce the hardware cost of computer systems. However, a user of such a computer system cannot monitor the computer system through remote connection via LAN if there is no BMC installed to the computer system, therefore the convenience in monitoring multiple computer systems remotely cannot be achieved. Moreover, a system administrator has to go on site to maintain such a computer system, therefore more human power, expense, and time are consumed, and the computer system cannot be monitored in real-time and cost in system management is also increased.

### SUMMARY OF THE INVENTION

Accordingly, the present invention is directed to a method for remotely monitoring a system, wherein a computer system is monitored by parsing a remote management control protocol (RMCP) packet received by the computer system.

The present invention provides a method for remotely monitoring a computer system. The method includes following steps. First, a network packet sent by a remote device is received. Whether the network packet is a RMCP packet or not is then determined. If the network packet is a RMCP packet, the data content in the RMCP packet is parsed and a corresponding monitoring operation is executed to obtain a monitoring result. Finally, the monitoring result is transmitted to the remote device.

According to an embodiment of the present invention, in the method for remotely monitoring a system, the step of determining whether or not the network packet is a RMCP packet further includes determining whether or not the network packet is a RMCP packet according to a header file of the network packet.

According to an embodiment of the present invention, in the method for remotely monitoring a system, the step of parsing the data content of the RMCP packet further includes converting the data content of the RMCP packet into a corresponding intelligent platform management interface (IPMI) message.

According to an embodiment of the present invention, in the method for remotely monitoring a system, the step of executing a monitoring operation corresponding to the data content of the RMCP packet to obtain a monitoring result further includes obtaining a sensor corresponding to the IPMI message and executing the monitoring operation by using the sensor to obtain the monitoring result.

According to an embodiment of the present invention, in the method for remotely monitoring a system, the sensor further includes a control chip coupled to the computer system, and the control chip includes one of a south bridge chip and a north bridge chip.

According to an embodiment of the present invention, in the method for remotely monitoring a system, the step of executing the monitoring operation by using the sensor to obtain the monitoring result further includes issuing a monitoring command to the sensor through the control chip so as to obtain the monitoring result.

According to an embodiment of the present invention, in the method for remotely monitoring a system, the sensor includes one of a temperature sensor and a fan rotation speed sensor.

According to an embodiment of the present invention, in the method for remotely monitoring a system, the monitoring operation includes monitoring one of the system temperature, the fan rotation speed, the voltage level of the power supply circuit, and the status of the casing of the computer system.

According to an embodiment of the present invention, in the method for remotely monitoring a system, the computer system includes a servo system.

According to the present invention, when a computer system receives a network packet sent by a remote device, it determines whether or not the network packet is a RMCP packet. If so, a sensor corresponding to the data content of the RMCP packet is turned on to execute a monitoring operation to the computer system and a monitoring result is transmitted back to the remote device. Accordingly, the computer system can be remotely monitored through the network without using baseboard management controller (BMC).

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for remotely monitoring a system according to an embodiment of the present invention.

FIG. 2 is a flowchart illustrating a method for remotely monitoring a system according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

If a computer system without a baseboard management controller (BMC) is provided with the functionality of parsing a remote management control protocol (RMCP) packet sent by a remote device, the computer system is then able to execute the corresponding monitoring operation and transmit a monitoring result back to the remote device, and accordingly the purpose of remotely monitoring the computer system can be achieved. A method for remotely monitoring a system is provided by the present invention based on foregoing idea. Embodiments of the present invention will be described below in details.

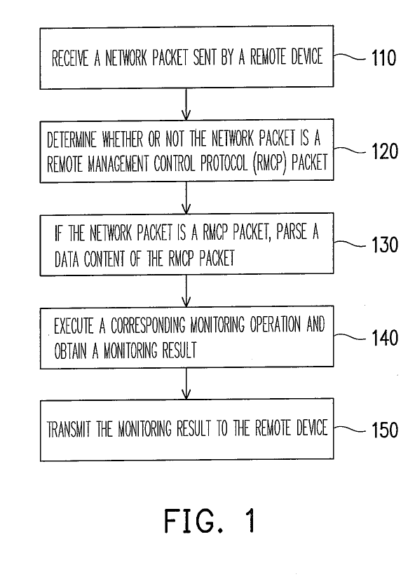

FIG. 1 is a flowchart illustrating a method for remotely monitoring a system according to an embodiment of the present invention. The present embodiment explains in details the procedure of a remote device remotely monitoring a computer system through a network, wherein the computer system may be a servo system. For the convenience of description, here the remote device and the computer system are assumed to be in the same local area network (LAN), and the two can transmit message or data back and forth via the LAN.

Referring to FIG. 1, first, as in step 110, when a user is about to check whether or not the computer system is working properly, a remote device transmits a network packet to the computer system via the LAN, and the computer system receives the network packet.

After the computer system receives the network packet, it determines whether the network packet is a RMCP packet in step 120. Next, as in step 130, if the computer system determines that the network packet is a RMCP packet, it captures the data content of the network packet.

Next, in step 140, the computer system executes a corresponding monitoring operation according to the captured data content and obtains a monitoring result. For example, the monitoring operation of the computer system includes monitoring the system temperature (for example, the temperature of the CPU or main board), the fan rotation speed, and the voltage level of the power supply circuit of the computer system and checking whether the casing of the computer is open.

Finally, as in step 150, the computer system transmits the monitoring result generated from the monitoring operation back to the remote device via the LAN. The system administrator who works with the remote device then determines whether the computer system is working properly according to the monitoring result. Accordingly, the system administrator can take appropriate action when the computer system is determined abnormal.

How the computer system parses the received network packet and executes corresponding monitoring operation will be further explained herein with reference to another embodiment of the present invention.

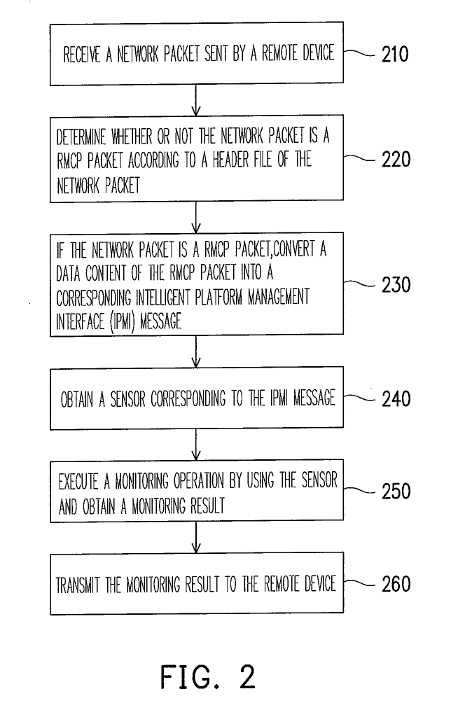

FIG. 2 is a flowchart illustrating a method for remotely monitoring a system according to another embodiment of the present invention. Referring to FIG. 2, assuming a remote device is used for monitoring a computer system, first, the computer system receives a network packet sent by the remote device via the network as in step 210.

Next, as in step 220, the computer system determines whether the network packet is a RMCP packet by capturing and checking a header file of the network packet.

In step 230, if the network packet is a RMCP packet, the computer system converts the data content of the packet into a corresponding intelligent platform management interface (IPMI) message.

After that, in step 240, the computer system obtains a corresponding sensor according to the IPMI message. For example, the sensor may be a temperature sensor disposed on the CPU or the main board of the computer system, a fan rotation sensor for detecting the rotation speed of the fan, a meter for measuring the voltage level, or a tact switch disposed on the casing of the computer system for detecting whether the casing has been opened; however, the type of the sensor is not limited herein.

Once an appropriate sensor is obtained, the monitoring operation to the computer system is executed through the sensor and a monitoring result is obtained in step 250. In the present embodiment, the various sensors disposed in the computer system are all coupled to a control chip of the computer system. The computer system can issue a monitoring command through the control chip to the corresponding sensor and obtain the monitoring result after the monitoring operation is completed. The control chip may be a south bridge chip or a north bridge chip; however, the type thereof is not limited herein.

After obtaining the monitoring result, the computer system transmits the monitoring result back to the remote device via the network, as in step 260. The system administrator of the remote device then takes corresponding action to the computer system according to the monitoring result.

In summary, the method for remotely monitoring a system provided by the present invention has at least following advantages:
1. a network packet containing a monitoring operation is transmitted to a computer system, and the computer system then parses the network packet and executes the corresponding monitoring operation, thus, the purpose of remotely monitoring the computer system is achieved.
2. the computer system can parse the content of the network packet and execute the corresponding monitoring operation without any additional hardware equipment, thus, the hardware cost for monitoring the computer system is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for remotely monitoring a computer system, comprising:
receiving a network packet sent by a remote device;
determining whether or not the network packet is a remote management control protocol (RMCP) packet;
if the network packet is a RMCP packet, parsing a data content of the RMCP packet;
executing a monitoring operation corresponding to the data content and obtaining a monitoring result; and
transmitting the monitoring result to the remote device.

2. The method according to claim 1, wherein the step of determining whether or not the network packet is the RMCP packet further comprises:
determining whether or not the network packet is the RMCP packet according to a header file of the network packet.

3. The method according to claim 1, wherein the step of parsing the data content of the RMCP packet further comprises:
converting the data content into a corresponding intelligent platform management interface (IPMI) message.

4. The method according to claim 3, wherein the step of executing the monitoring operation corresponding to the data content and obtaining the monitoring result further comprises:
obtaining a sensor corresponding to the IPMI message; and
executing the monitoring operation by using the sensor and obtaining the monitoring result.

5. The method according to claim 4, wherein the sensor further comprises a control chip coupled into the computer system.

6. The method according to claim 5, wherein the step of executing the monitoring operation by using the sensor and obtaining the monitoring result further comprises:
issuing a monitoring command to the sensor through the control chip to obtain the monitoring result.

7. The method according to claim 5, wherein the control chip comprises one of a south bridge chip and a north bridge chip.

8. The method according to claim 4, wherein the sensor comprises one of a temperature sensor and a fan rotation speed sensor.

9. The method according to claim 1, wherein the monitoring operation comprises monitoring one of the system temperature, the fan rotation speed, the voltage level of the power supply circuit, and the status of the casing of the computer system.

10. The method according to claim 1, wherein the computer system comprises servo system.
